(19) United States
(12) Patent Application Publication
(10) Pub. No.: US 2008/0247451 A1
(43) Pub. Date: Oct. 9, 2008

(54) MEASUREMENT APPARATUS, MEASUREMENT METHOD, TEST APPARATUS, ELECTRONIC DEVICE, AND RECORDING MEDIUM

(75) Inventor: TAKAHIRO YAMAGUCHI, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 12/047,331

(22) Filed: Mar. 13, 2008

Related U.S. Application Data
(60) Provisional application No. 60/894,458, filed on Mar. 13, 2007.

(51) Int. Cl. H04B 17/00

(52) U.S. Cl. 375/226

(57) ABSTRACT

Provided is a measurement apparatus that measures jitter occurring in a data converter, including a measurement signal generating section that generates a measurement signal having a substantially constant period; a jitter injecting section that injects jitter of a deterministic signal having a predetermined jitter period into the measurement signal, and that inputs the resulting signal to the data converter; a jitter measuring section that measures a jitter string of a digital signal output by the data converter; and an extracting section that extracts data of the jitter string according to the jitter period of the jitter injected by the jitter injecting section.

### CROSS REFERENCE TO RELATED APPLICATION

The present application claims priority from a U.S. Provisional Application No. 60/894,458 filed on Mar. 13, 2007, the contents of which are incorporated herein by reference.

### BACKGROUND

1. Technical Field

The present invention relates to a measurement apparatus, a measurement method, a test apparatus, an electronic device, and a recording medium. In particular, the present invention relates to a measurement apparatus and a measurement method for measuring jitter occurring in a data converter.

2. Related Art

When testing and evaluating a multi-bit high-speed AD converter, aperture jitter measurement is very important because a larger slope in a discrete waveform generated by the AD converter results in a larger aperture uncertainty in the AD converter, which in turn causes a voltage error in the output of the AD converter.

As a result of this, the signal-to-noise ratio of the output of the AD converter is reduced. Here, the aperture jitter of the AD converter refers to a variation in aperture delay from the zero-cross timing of a sampling clock to a timing at which the analog input is held.

Furthermore, in digital communication, intermediate frequency undersampling is known to be particularly sensitive to the aperture jitter. Accordingly, evaluating and testing of the aperture jitter of the AD converter is also important for the development of software defined radios or the like.

Measuring the aperture jitter, however, is extremely difficult. New measurement methods are constantly being proposed, but as of yet no methods exist that can measure the aperture jitter with a simple measurement system and that are also suitable for mass production testing.

Conventional measurement methods measure the aperture jitter by measuring a voltage and extrapolating the aperture jitter from the measured voltage. For example, the voltage noise induced by the aperture jitter is measured by measuring the output of the AD converter. Then, the aperture jitter is indirectly estimated on a time axis based on the measured voltage noise. In this case, in order to estimate the power of the noise caused by the aperture jitter, an output code of the AD converter must be acquired very many times to measure the variation therein.

FIGS. 15A and 15B describe a measurement of the aperture delay. FIG. 15A is a schematic view showing a system that measures the aperture delay. FIG. 15B shows a waveform V_{IN} output by a signal generator 1000 and a waveform of a sampling clock CK output by a waveform shaper 1200.

The signal generator 1000 generates the waveform V_{IN} and inputs the generated waveform into the AD converter 1100. The edges of the waveform V_{IN} have a certain slope, as shown in FIG. 15B. The waveform shaper 1200 delays the waveform V_{IN} by a delay time T to generate a sampling clock with the thus shaped waveform. Therefore, the edges of the waveform V_{IN} and the sampling clock CK is aligned are the time axis.

Here, the delay time T of the waveform shaper 1200 gradually increases from T=T₀ reach the delay time T=T₀+τ observed when the code output by the AD converter 1100 corresponds to a zero-cross level. This increase τ in the delay time corresponds to the aperture delay time.

In the system shown in FIG. 15A, phase noise of the signal generator is assumed to be extremely small. An offset voltage is applied to the waveform V_{IN} output by the signal generator, and the resulting waveform is input to the AD converter 1100. As shown in FIG. 15B, the phase of the sampling clock in relation to the waveform V_{IN} is constant, so that, ideally, the AD converter 1100 outputs identical codes corresponding to the offset voltage for each sampling clock.

In practice, however, the codes output by the AD converter 1100 are not the same because of the aperture jitter of the AD converter 1100 and internal wideband noise, meaning that adjacent codes or the like are output. FIG. 16 shows a result obtained by changing the offset voltage and measuring variation of the codes output by the AD converter 1100 according to each level of the offset voltage.

In FIG. 16, the horizontal axis represents the offset voltage and the vertical axis represents the output code variation. The offset voltage at each integer value corresponds to the code output by the AD converter 1100. For example, in a case where the offset voltage “132” is set, the AD converter 1100 ideally outputs a constant output code corresponding to “132”, so that the standard deviation is zero. In a case where the offset voltage “132.5” is set, substantially half of the output codes output by the AD converter are the output codes corresponding to “132” and the other half are output codes corresponding to “133”, so that the standard deviation of the output code is approximately “0.5”.

However, even when the offset voltage “132” is set, the AD converter 1100 outputs codes other than the codes corresponding to “132” because of the aperture jitter, wideband noise, and the like described above. The voltage noise or the like induced by the aperture jitter is measured by measuring such dispersion of the output codes, and can then be used to estimate the aperture jitter.

When the offset voltage “133” is set, the dispersion should be the same as the case where the offset voltage “132” is set, but the standard deviation of the output codes becomes greater due to the effects of quantization noise and nonlinearity of the AD converter 1100. Here, the nonlinearity of the AD converter 1100 refers to differential nonlinearity and the like, which is a result of the ranges of the output codes not being uniform. The range of the output code may be a range of the input voltage corresponding to the output code. When the aperture jitter is estimated based on the dispersion of the output codes of the AD converter 1100 as described above, the nonlinearity of the AD converter 1100 exerts an undesirable effect on the measurement.

In the manner described above, it is difficult to accurately obtain the aperture jitter using conventional measurement methods that estimate the aperture jitter based on the amplitude noise. Because the output codes must be acquired very many times to calculate the variation therein using conventional methods, the measurement requires a large amount of time, and is therefore unsuitable for mass production testing.

### SUMMARY

Therefore, it is an object of an aspect of the innovations herein to provide a measurement apparatus, a measurement method, a test apparatus, an electronic device, and a recording medium, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary apparatus may include a measurement apparatus that measures jitter occurring in a data converter, including a measurement signal generating section that generates a measurement signal having a substantially constant period; a jitter injecting section that injects jitter of a deterministic signal having a predetermined jitter period into the measurement signal, and that inputs the resulting signal to the data converter; a jitter measuring section that measures a jitter string of a digital signal output by the data converter; and an extracting section that extracts data of the jitter string according to the jitter period of the jitter injected by the jitter injecting section. Further exemplary apparatuses may include a test apparatus that uses the measurement apparatus, an electronic device that uses the measurement apparatus, and a program that causes the measurement apparatus to function.

According to a second aspect related to the innovations herein, one exemplary apparatus may include a measurement apparatus that measures jitter occurring in a device under test, including a jitter injecting section that injects jitter of a deterministic signal having a predetermined jitter period into a signal under measurement, and causes the device under test to output the signal under measurement; a data converter that detects a level of the signal under measurement according to a timing signal supplied thereto; a jitter measuring section that measures a jitter string of a digital signal output by the data converter; an extracting section that extracts data of the jitter string according to the jitter period of the jitter injected by the jitter injecting section; a converter under test inherent jitter calculating section that calculates jitter occurring in the data converter based on the data extracted by the extracting section; and an input system jitter calculating section that calculates jitter included in the signal under measurement based on a value obtained by subtracting the jitter value calculated by the converter under test inherent jitter calculating section from the jitter value of the jitter string measured by the jitter measuring section. Further exemplary apparatuses may include a test apparatus that uses the measurement apparatus, an electronic device that uses the measurement apparatus, and a program that causes the measurement apparatus to function.

According to a third aspect related to the innovations herein, one exemplary method may include a measurement method for measuring jitter occurring in a data converter, including generating a measurement signal having a substantially constant period; injecting jitter of a deterministic signal having a predetermined jitter period into the measurement signal, and inputting the resulting signal to the data converter; measuring a jitter string of a digital signal output by the data converter; and extracting data of the jitter string according to the jitter period of the jitter injected by the jitter injecting section.

According to a fourth aspect related to the innovations herein, one exemplary apparatus method may include a measurement method for measuring jitter occurring in a device under test, including injecting jitter of a deterministic signal having a predetermined jitter period into a signal under measurement, and causing the device under test to output the signal under measurement; detecting a level of the signal under measurement according to a timing signal supplied thereto, by using a data converter; measuring a jitter string of a digital signal output by the data converter; extracting data of the jitter string according to the jitter period of the jitter injected into the signal under measurement; calculating period jitter occurring in the data converter based on the extracted data; and calculating jitter included in the signal under measurement based on a value obtained by subtracting the jitter value of the period jitter from the jitter value of the jitter string.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary configuration of a measurement apparatus 100 according to an embodiment of the present invention.

FIG. 2A shows an example of the measurement signal to which sinusoidal jitter is injected by the jitter injecting section 20.

FIG. 2B shows an example of the probability density function of the sinusoidal jitter generated by the jitter injecting section 20.

FIG. 3 describes an exemplary operation of the AD converter 300.

FIG. 4 shows an exemplary configuration of the jitter measuring section 50.

FIG. 5A shows an example of a spectrum of the digital signal output by the AD converter 300.

FIG. 5B shows an example of a spectrum obtained by extracting a frequency component of a prescribed band using the analytic signal calculating section 52.

FIG. 6A shows an example of the analytic signal calculated by the analytic signal calculating section 52.

FIG. 6B shows an example of instantaneous phase noise.

FIG. 7A shows an exploded portion of the instantaneous phase noise.

FIG. 7B shows an example of an autocorrelation function of the instantaneous phase noise shown in FIG. 7A.

FIG. 8A shows an example of the probability density function of the sine jitter injected to the measurement signal by the jitter injecting section 20.

FIG. 8B shows an exemplary histogram of a narrowband component in the N-period jitter string extracted by the extracting section 70.

FIG. 8C shows an exemplary histogram of a wideband component in the N-period jitter string extracted by the extracting section 70.

FIG. 9A shows an example of the probability density function of the sine jitter injected to the measurement signal by the jitter injecting section 20, in the same manner as FIG. 8A.

FIG. 9B shows an exemplary histogram of a narrowband component in the N cycle to N cycle jitter string extracted by the extracting section 70.

FIG. 9C shows an exemplary histogram of a wideband component in the N cycle to N cycle jitter string extracted by the extracting section 70.

FIG. 10 shows exemplary values of the results of the tests shown in FIGS. 8 and 9.

FIG. 11 shows an exemplary configuration of the measurement apparatus 200 according to another embodiment.

FIG. 12A shows an exemplary configuration of a test apparatus 500 according to another embodiment.

FIG. 12B shows an exemplary configuration of a test apparatus 600 according to another embodiment.

FIG. 13A shows an exemplary configuration of an electronic device 700 according to another embodiment.

FIG. 13B shows an exemplary configuration of an electronic device 800 according to another embodiment.

FIG. 14 shows an exemplary configuration of a computer 1900.

FIG. 15A is a schematic view showing a system that measures the aperture delay.

FIG. 15B shows a waveform V_{IN} output by a signal generator 1000 and a waveform of a sampling clock CK output by a waveform shaper 1200.

FIG. 16 shows a result obtained by changing the offset voltage and measuring dispersion of the codes output by the AD converter 1100 according to each offset voltage.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

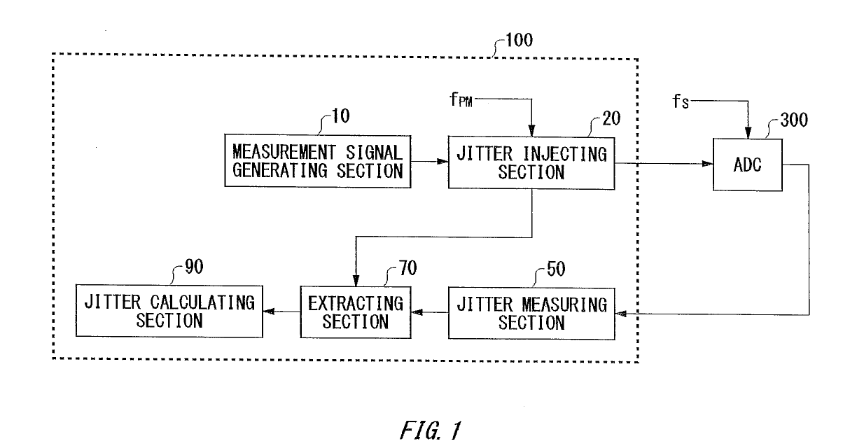

FIG. 1 shows an exemplary configuration of a measurement apparatus 100 according to an embodiment of the present invention. The measurement apparatus 100 is an apparatus that measures jitter occurring in an AD converter 300, and is provided with a measurement signal generating section 10, a jitter injecting section 20, a jitter measuring section 50, an extracting section 70, and a jitter calculating section 90. The AD converter 300 is a circuit that converts an analog signal input thereto into a digital signal, and is exemplified by a data converter. Included in the scope of such a data converter is a DA converter that converts a digital signal into an analog signal.

The measurement signal generating section 10 generates a measurement signal having a substantially constant period. For example, the measurement signal generating section 10 may generate as the measurement signal a sine wave signal having a constant period, a rectangular wave signal having a constant period, or the like.

The jitter injecting section 20 injects jitter of a deterministic signal having a predetermined jitter period to the measurement signal. Here, the jitter of the deterministic signal is sinusoidal jitter, triangular wave jitter, or the like. The jitter injecting section 20 of the present embodiment may inject the sinusoidal jitter to the measurement signal by phase modulating or frequency modulating the measurement signal with a sine wave having a jitter frequency f_{PM}. More specifically, the jitter injecting section 20 may receive a sine wave signal having a jitter frequency f_{PM} from the outside and phase modulate or frequency modulate the measurement signal with the received sine wave signal.

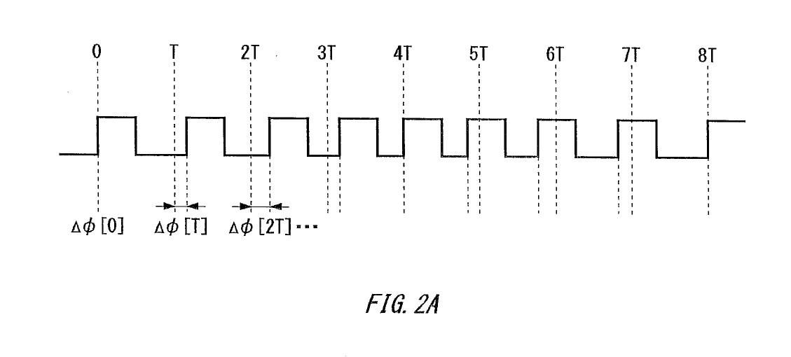

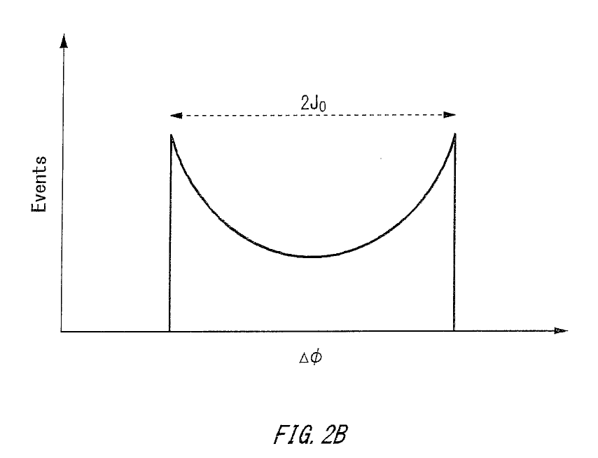

The jitter injecting section 20 may instead inject jitter to the measurement signal by changing the delay amount of a delay circuit disposed between the measurement signal generating section 10 and the AD converter 300 by the sine wave having the jitter period. Here, an exemplary operation of the jitter injecting section 20 is described below with reference to FIGS. 2A and 2B.

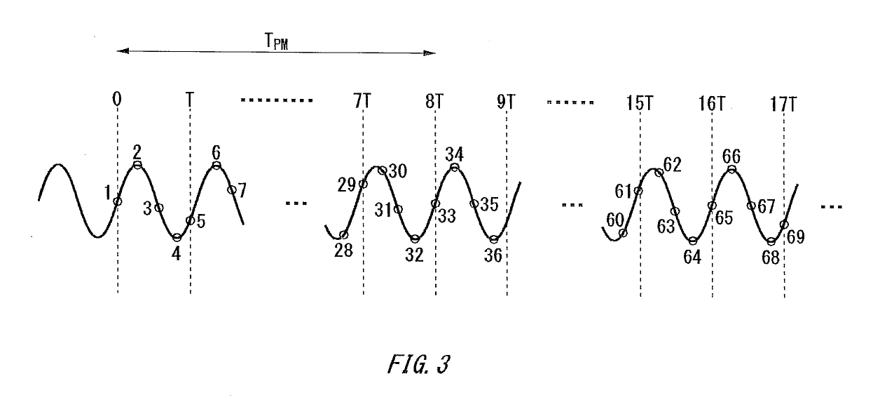

The AD converter 300 detects a level of the input measurement signal according to a sampling clock having a prescribed frequency fs. The AD converter 300 outputs a digital signal (code) corresponding to the detected level. An exemplary operation of the AD converter 300 is described below with reference to FIG. 3. The measurement apparatus 100 may be further provided with a circuit that generates the sampling clock and supplies the sampling clock to the AD converter 300.

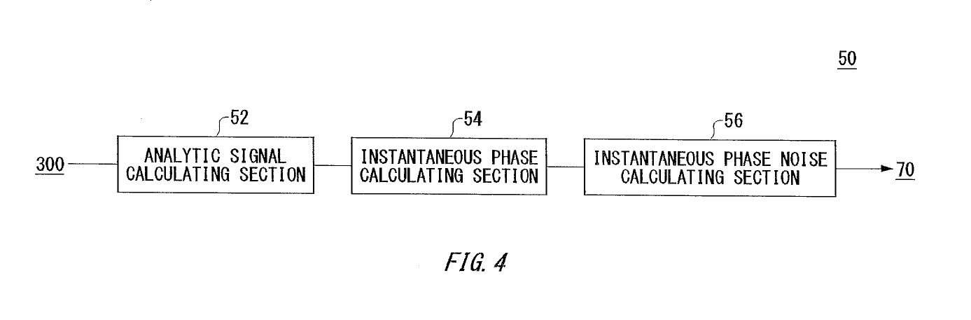

The jitter measuring section 50 measures a jitter string in the digital signal output by the AD converter 300. The jitter string may refer to a series of values of jitter (or phase noise) that is included in the digital signal lined up discretely on the time axis. The jitter string may instead refer to a series obtained from a repeating waveform of the values of the jitter included in the digital signal on the time axis. A detailed description of the configuration and operation of the jitter measuring section 50 is given below with reference to FIGS. 4 to 6.

The extracting section 70 extracts the data of the jitter string according to the jitter period of the sinusoidal jitter injected by the jitter injecting section 20, and outputs the extracted data to the jitter calculating section 90. For example, the extracting section 70 may extract the data of the jitter string with a data interval substantially equal to the jitter period, or may extract the data of the jitter string with a data interval substantially equal to an integer multiple of the jitter period. In a case where the jitter string is a repeating waveform, the extracting section 70 may extract each piece of data by sampling the jitter string with a period substantially equal to the jitter period or with a period substantially equal to an integer multiple of the jitter period.

By extracting the data corresponding to the jitter period from the jitter string in the manner described above, the effects of inherent phase noise in the sampling clock, noise in the measurement signal, and the like can be eliminated, so that the aperture jitter occurring in the AD converter 300 can be measured. Furthermore, values in a time domain can be directly acquired without converting the aperture jitter into a voltage error.

The following description uses formulas to explain how the effect of the inherent phase noise of the sampling clock or the like can be removed by the process described above. The measurement signal x(t) to which the sinusoidal jitter is injected is expressed by Expression 1.

x(t)=cos [2πf_{CLK}t+J₀ sin(2πf_{PM}t+β)] Expression 1

Here, f_{CLK} represents the carrier frequency of the measurement signal output by the measurement signal generating section 10, f_{PM} represents the jitter frequency of the sinusoidal jitter injected by the jitter injecting section 20, J₀ represents the amplitude of the sinusoidal jitter, and β represents the initial phase of the sinusoidal jitter.

A sampling string x(kTs) of Expression 2 can be obtained when the AD converter 300 samples the measurement signal x(t) of Expression 1 with a sampling period Ts.

x(kTs)=cos [2πf_{CLK}kTs+J₀ sin(2πf_{PM}kTs+β)+m(kTs)−n(kTs)] Expression 2

Here, k is an integer, m(kTs) is the inherent phase noise in the sampling clock supplied from the outside to the AD converter 300, and n(kTs) is internal timing noise of the AD converter 300. The internal timing noise includes the aperture jitter of the AD converter 300 and the jitter of the sampling clock occurring in the AD converter 300, for example.

Here, suppose that the jitter injecting section 20 injects, to the measurement signal x(t), sinusoidal jitter that fulfills the condition of Expression 3. In other words, suppose that the jitter injecting section 20 injects sinusoidal jitter large enough that the inherent phase noise in the sampling clock can be ignored. Sinusoidal jitter large enough for the inherent phase noise in the sampling clock to be ignored may refer to an amount such that the effect of the inherent phase noise in the sampling clock on the measurement result is smaller than measurement resolution being sought.

J₀ sin(2πf_{PM}kTs+β)>>m(kTs) Expression 3

When the jitter injecting section 20 injects the sinusoidal jitter that fulfills the condition of Expression 3, the internal timing noise n(kTs) also becomes sufficiently large in relation to the inherent phase noise m(kTs). Generally, the sampling clock jitter occurring in the AD converter 300, which is included in the internal timing noise, is greater than the inherent phase noise of the sampling clock occurring outside of the AD converter 300.

Furthermore, the aperture jitter included in the internal timing noise n(kTs) depends on the slope of the waveform of the measurement signal input to the AD converter 300. In other words, the voltage error caused by the internal timing noise increases as the slope of the waveform of the measurement signal increases, and the voltage error caused by the internal timing noise decreases as the slope of the waveform of the measurement signal decreases. On the other hand, the inherent phase noise m(kTs) has very little dependence on the slope of the waveform of the measurement signal, and therefore does not become large even when the sinusoidal jitter is injected to the measurement signal.

Therefore, by injecting the sinusoidal jitter having a sufficiently large amplitude,

J₀ sin(2πf_{PM}kTs+β)>>m(kTs)

and

n(kts)>>m(kts)

are obtained, so that the inherent phase noise m(kTs) of the sampling clock can be ignored. When the sampling string that fulfills the aforementioned conditions is input into the jitter measuring section 50, the jitter string of Expression 4 is obtained. Expression 4:

$$Δφ ( kTs ) = - {J}_{0} sin ( \frac{2 π}{{T}_{PM}} kTs + β ) + n ( kTs )$$

Here, T_{PM} is the jitter period, and T_{PM}=1/f_{PM}.

When data is extracted from the data Δφ(kTs) at an interval equal to an integer multiple of the jitter period T_{PM}, Expression 4 is transformed into Expression 5.

Δφ(t;T_{PM})={(t,J₀ sin(β)+n(t))|t=kT_{PM}} Expression 5

More specifically, by extracting data from the jitter string Δφ(kTs), which is measured after being injected with the sinusoidal jitter, according to the period of the sinusoidal jitter, the effect of the sinusoidal jitter can be eliminated. Furthermore, by injecting the sinusoidal jitter having an amplitude large enough that a correlation value among the extracted pieces of data is substantially one, the measurement apparatus 100 can perform a measurement in which the effect of the inherent phase noise of the sampling clock is eliminated. The jitter injecting section 20 may adjust the amplitude of the sinusoidal jitter injected to the measurement signal such that the correlation value of the pieces of data extracted by the extracting section 70 is substantially one. It is desirable that the jitter period T_{PM} be an integer multiple of the sampling period Ts.

Next, N-period jitter is calculated from the jitter string of Expression 5. Here, N is an integer greater than or equal to one. The N-period jitter refers to period jitter observed when a time interval spanning N cycles of the jitter period, which is the sampling interval, is viewed as one period. The N-period jitter is defined by Expression 6.

J[k;N]=Δφ[k+1;N]−Δφ[k;N] Expression 6

In other words, data is extracted in every N cycles from the jitter string, and a difference string is calculated from the difference between adjacent pieces of extracted data. This difference string represents the jitter string of the N-period jitter.

When the N-period jitter defined by Expression 6 is calculated from the jitter string of Expression 5, Expression 7 is obtained. Expression 7:

J[k;T_{PM}]={(k,n[k+1]−n[k])|k=kT_{PM}}

As shown by Expression 7, by using the process described above, the effect of the inherent phase noise in the sampling clock and in the measurement signal can be eliminated, so that the N-period jitter caused by the internal timing noise n(t) of the sampling system can be directly measured.

The jitter calculating section 90 shown in FIG. 1 may calculate the N-period jitter by performing the process described using Expression 7 on the jitter string expressed by Expression 5 from the extracting section 70. For example, the jitter calculating section 90 may calculate the difference string formed by the differences between adjacent data values in the data string received from the extracting section 70.

In this case, the jitter string calculated by the jitter calculating section 90 is expressed by the data string shown below, for example.

[n(2T_{PM})−n(T_{PM})], [n(3T_{PM})−n(2T_{PM})], [n(4T_{PM})−n(3T_{PM})], . . . .

Since N=1 in this case, the difference string corresponds to a string of one period of jitter.

The jitter calculating section 90 may calculate the difference string formed by the differences between the data value arranged at intervals of N in the data string input from the extracting section 70. This difference string corresponds to the N-period jitter string. The jitter calculating section 90 may calculate a root-mean-square value of the period jitter by squaring the average of the jitter string calculated as described above. The jitter calculating section 90 may also obtain a probability density function of the period jitter.

The jitter calculating section 90 may further calculate the difference string formed by the difference between adjacent data values in the N-period jitter string. This difference string corresponds to N cycle to N cycle jitter occurring in the AD converter 300. The N cycle to N cycle jitter refers to cycle to cycle jitter observed when a time interval spanning N cycles of the jitter period, which is the sampling interval, is viewed as one period. The N cycle to N cycle jitter is defined by the expression below.

J[k;N]=Δφ[k+1;N]−Δφ[k;N]

At a time when N=1, for example, the N cycle to N cycle jitter string calculated by the jitter calculating section 90 is expressed by the data string shown below.

[n(3T_{PM})−n(T_{PM})], [n(4T_{PM})−n(2T_{PM})], [n(5T_{PM})−n(3T_{PM})], . . . .

Furthermore, the jitter calculating section 90 may obtain the effective value and the probability density function of the N cycle to N cycle period jitter.

The jitter calculating section 90 may obtain a timing jitter string based on the jitter string of the period jitter or the N cycle to N cycle jitter. The timing jitter refers to fluctuation in an amount that each edge timing of the signal under measurement varies from an ideal timing of the each edge timing, for example, and can be calculated by integrating the period jitter. The jitter calculating section 90 may calculate the timing jitter string by cumulatively adding the data values of the period jitter string. In this case, the jitter string calculated by the jitter calculating section 90 is expressed by the data string shown below, for example.

[n(T_{PM})], [n(T_{PM})+n(2T_{PM})], [n(T_{PM})+n(2t_{PM})+n(3T_{PM})], . . . , [Σ[n(kT_{PM})]

As described above, by using the measurement apparatus 100 of the present embodiment, the AD converter 300 samples the measurement signal to which the sinusoidal jitter is injected. After the sampling, data is extracted from the sampling string with a period equal to an integer multiple of the jitter period. In this manner, the effect of the inherent phase noise in the sampling clock and in the measurement signal can be eliminated, so that the internal timing noise in the sampling system can be directly measured.

FIG. 2A and FIG. 2B describe an exemplary operation of the jitter injecting section 20. FIG. 2A shows an example of the measurement signal to which the sinusoidal jitter is injected by the jitter injecting section 20. FIG. 2B shows an example of the probability density function of the sinusoidal jitter generated by the jitter injecting section 20. It should be noted that FIG. 2A shows a measurement signal having a rectangular waveform, but the measurement signal may instead have a sine waveform or the like.

As shown in FIG. 2A, for example, the phases of the edges of the measurement signal are gradually changed by the sinusoidal jitter Δφ(kT). Here, k is an integer and T is the period of the measurement signal. The amplitude of the sinusoidal jitter Δφ(kT) is given by J₀, as shown in FIG. 2B. In the example shown in FIG. 2A, one period of the sinusoidal jitter is substantially equal to eight periods of the measurement signal, but the sinusoidal jitter is not limited to such a period. The sinusoidal jitter may have a period equal to an arbitrary integer multiple of the period of the measurement signal or may have an arbitrary period that is unrelated to the period of the measurement signal.

FIG. 3 describes an exemplary operation of the AD converter 300. The waveform shown in FIG. 3 represents the measurement signal input into the AD converter 300. The ideal zero-cross timings of the measurement signal are represented by 0, T, 2T, . . . The jitter injecting section 20 may generate the sinusoidal jitter having a jitter period equal to an integer multiple of the sampling period Ts in the AD converter 300 and an integer multiple of the period T of the measurement signal. In FIG. 3, for example, the period T_{PM} of the sinusoidal jitter is eight times the period T of the measurement signal and thirty-two times the sampling period Ts in the AD converter 300.

The jitter measuring section 50 shown in FIG. 1 receives the sampling string shown in FIG. 3 as a digital signal, and measures the jitter string of the received digital signal based on the sampling string.

FIG. 4 shows an exemplary configuration of the jitter measuring section 50. The jitter measuring section 50 includes an analytic signal calculating section 52, an instantaneous phase calculating section 54, and an instantaneous phase noise calculating section 56.

The analytic signal calculating section 52 receives the sampling string (digital signal) output by the AD converter 300 and calculates an analytic signal of the sampling string. For example, the analytic signal calculating section 52 can obtain the analytic signal of the input signal by setting the input signal to be a real part of the analytic signal and setting a Hilbert transform of the input signal to be an imaginary part of the analytic signal. The analytic signal can instead be calculated by performing a Fourier transform on the supplied digital signal to obtain the spectrum of the frequency domain and performing an inverse Fourier transform on the spectrum with the negative frequency components of the spectrum being set equal to zero.

The instantaneous phase calculating section 54 calculates an instantaneous phase of the digital signal based on the analytic signal supplied from the analytic signal calculating section 52. For example, the instantaneous phase calculating section 54 may calculate the instantaneous phase of the digital signal by calculating an inverse arc tangent of the imaginary part and the real part of the analytic signal.

The instantaneous phase noise calculating section 56 calculates instantaneous phase noise of the digital signal based on the instantaneous phase supplied from the instantaneous phase calculating section 54. For example, the instantaneous phase noise calculating section 56 may calculate the instantaneous phase noise of the digital signal by eliminating an ideal phase component of the digital signal from the instantaneous phase supplied thereto.

The instantaneous phase supplied from the instantaneous phase calculating section 54 has a discontinuous waveform that cycles between −π and +π. The instantaneous phase noise calculating section 56 may calculate the instantaneous phase of a continuous waveform by unwrapping the instantaneous phase supplied thereto. The unwrapping process may refer to a process in which π is added to the instantaneous phase waveform at predetermined intervals.

The instantaneous phase noise calculating section 56 may linearly approximate the waveform of the instantaneous phase on which the unwrapping process has been performed. The instantaneous phase noise calculating section 56 may then calculate the instantaneous phase noise by eliminating a linear component from the waveform of the instantaneous phase on which the unwrapping process has been performed.

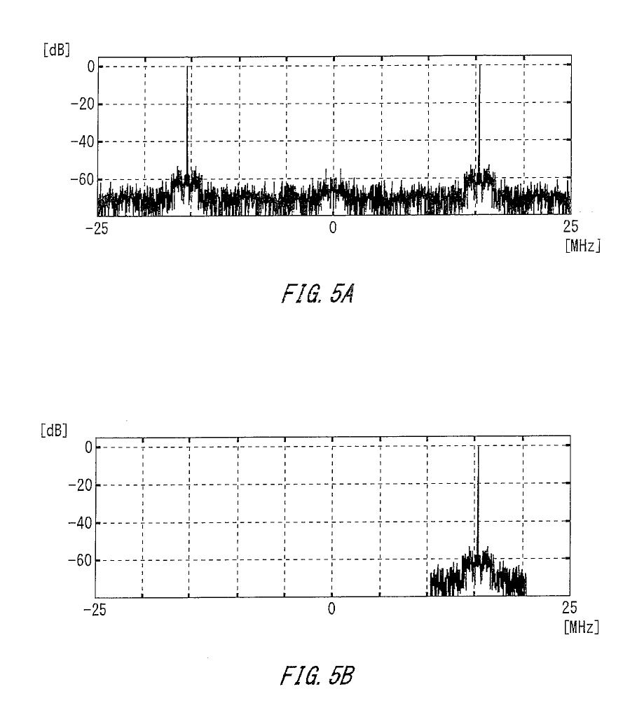

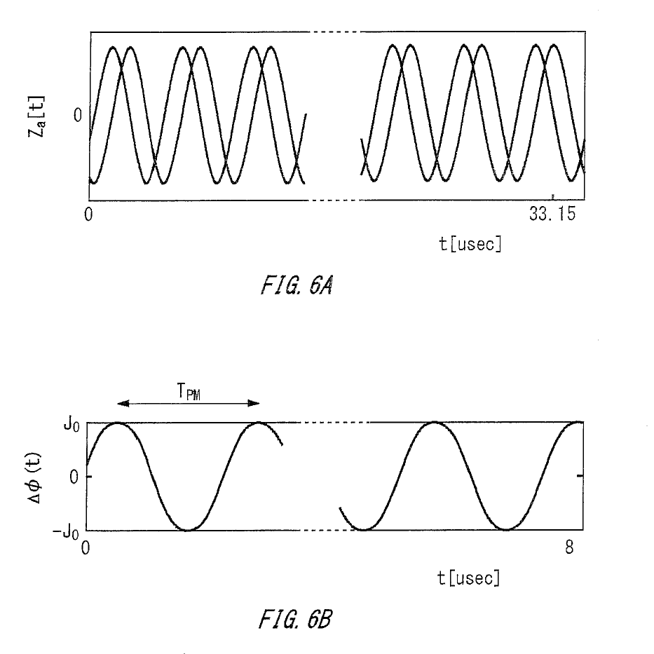

FIGS. 5A to 6B describe an exemplary operation of the jitter measuring section 50. As shown in FIG. 5A, the analytic signal calculating section 52 may calculate the spectrum of the frequency domain by Fourier transforming the digital signal. As shown in FIG. 5B, the analytic signal calculating section 52 may extract frequency components within a prescribed band from the calculated spectrum. The analytic signal calculating section 52 may calculate the analytic signal, such as that shown in FIG. 6A, by inverse Fourier transforming the extracted frequency components.

As described above, the instantaneous phase calculating section 54 calculates the instantaneous phase of the digital signal based on the analytic signal supplied thereto. The instantaneous phase noise calculating section 56 calculates the instantaneous phase noise of the digital signal based on the calculated instantaneous phase. In the present embodiment, the jitter injecting section 20 injects the sinusoidal jitter having a sufficiently large amplitude to the measurement signal. Therefore, the effect of the sinusoidal jitter in the instantaneous phase noise calculated by the instantaneous phase noise calculating section 56 is large, as shown in FIG. 6B.

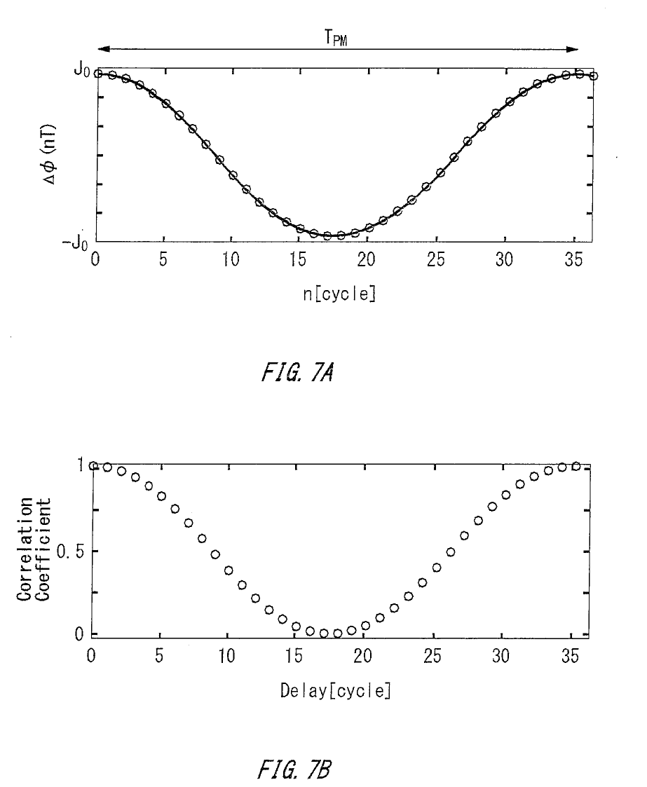

FIG. 7A shows an enlarged portion of the instantaneous phase noise. In FIG. 7A, the horizontal axis indicates the period of the measurement signal. As shown in FIG. 7A, the jitter injecting section 20 may inject to the measurement signal the sinusoidal jitter having a jitter period T_{PM} that is sufficiently larger than the period of the measurement signal. The period of the measurement signal in the present embodiment is approximately 0.1 microseconds, and the jitter period T_{PM} of the sinusoidal jitter is approximately 3.3 microseconds.

FIG. 7B shows an example of an autocorrelation function of the instantaneous phase noise shown in FIG. 7A. In FIG. 7B, the horizontal axis represents a time difference in the instantaneous phase noise, and the vertical axis represents a correlation value at each time difference. Since the sinusoidal jitter injected to the measurement signal has a sufficiently large amplitude as described above, the sinusoidal jitter becomes the main component of the instantaneous phase noise. Because of this, the autocorrelation value of the instantaneous phase noise is approximately equal to one when the time difference in the instantaneous phase noise is equal to an integer multiple of the jitter period T_{PM} (33 cycles in the present embodiment) of the sinusoidal jitter.

Because of this, the effect of the sinusoidal jitter can be removed by the extracting section 70 extracting the value of the instantaneous phase noise at intervals of integer multiples of the jitter period. Furthermore, as described in relation to Expression 3, the effect of the inherent phase noise in the sampling clock can be removed by injecting the sinusoidal jitter having a sufficiently large amplitude. In other words, the measurement apparatus can measure the internal timing noise such as the aperture jitter in the AD converter 300.

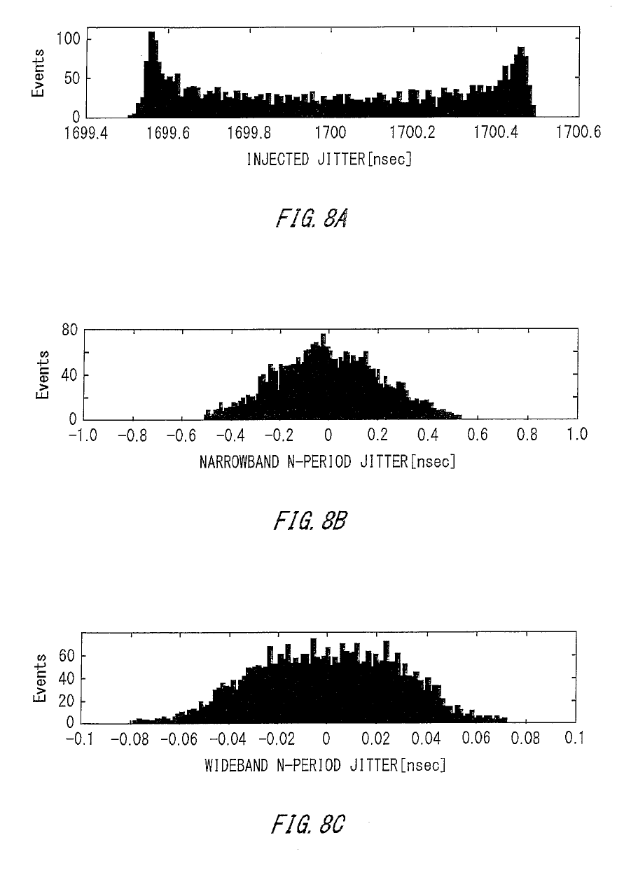

FIGS. 8A to 8C show examples of experimental results obtained by using the measurement apparatus 100 to measure the N-period jitter. In the present embodiment, a waveform that is obtained by phase modulating a 10 MHz sine wave with a sine wave of 300 KHz 1000 mV is input as the measurement signal to a 12-bit AD converter 300, whose effective number of bits is 10.3. Here, the frequency of the sampling clock input to the AD converter 300 is 40.96 MHz, and the inherent phase noise of the sampling clock is 20.8 psRMS.

FIG. 8A shows an example of the probability density function of the sinusoidal jitter injected to the measurement signal by the jitter injecting section 20. In FIG. 8A, the horizontal axis represents the amplitude of the sinusoidal jitter and the vertical axis represents the probability density at each amplitude.

FIG. 8B shows an exemplary histogram of narrowband components in the N-period jitter string extracted by the extracting section 70. The narrowband components refer to components passed through a band of sidebands occurring on both sides of the frequency component f_{PM} of the sinusoidal jitter in the spectrum of the N-period jitter string, for example.

FIG. 8C shows an exemplary histogram of wideband components in the N-period jitter string extracted by the extracting section 70. The wideband components may refer to frequency components passed through a region that is wider around the frequency component f_{PM} of the sinusoidal jitter than the above-described narrow band. In the present embodiment, the wideband components are components that are passed through a region of fs×2 at both sides of the frequency component f_{PM} of the sinusoidal jitter. It should be noted that fs is the frequency of the measurement signal generated by the measurement signal generating section 10.

Here, the narrowband jitter corresponds mainly to the jitter occurring in the sampling clock within the AD converter 300. The wideband jitter corresponds to the internal timing noise n(kTs), which includes the internal jitter of the sampling clock and also the aperture jitter or the like in the AD converter 300.

The internal jitter of the sampling clock, the aperture jitter, and the like are random jitter, and therefore the narrowband jitter and the wideband jitter follow a Gaussian distribution. As shown in FIG. 8C, however, the central region of the wideband jitter has an even distribution. Furthermore, as shown in FIG. 8B, the narrowband jitter has an inverted triangular distribution, which deviates from the Gaussian distribution. This deviation from the Gaussian distribution occurs because the effect of the sinusoidal jitter is not completely eliminated. For example, when transforming Expression 4 into Expression 5, in a case where the interval at which data is extracted contains an error in relation to the jitter period T_{PM}, the effect of the sinusoidal jitter cannot be completely eliminated, which leads to measurement results such as those shown in FIGS. 8B and 8C.

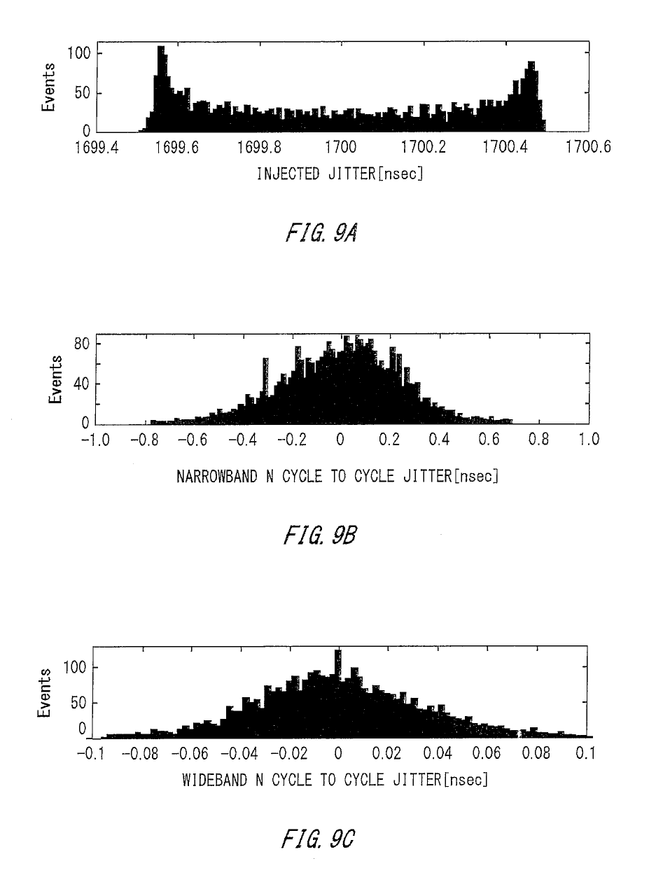

FIGS. 9A to 9C show examples of experimental results obtained by using the measurement apparatus 100 to measure the N cycle to N cycle jitter. In the present embodiment, the measurement conditions such as the frequency of the measurement signal are the same as the measurement conditions described in FIGS. 8A to 8C. In the same manner as FIG. 8A, FIG. 9A shows an example of the probability density function of the sinusoidal jitter injected to the measurement signal by the jitter injecting section 20.

FIG. 9B shows an exemplary histogram of narrowband components in the N cycle to N cycle jitter string extracted by the extracting section 70. FIG. 9C shows an exemplary histogram of wideband components in the N cycle to N cycle jitter string extracted by the extracting section 70.

As shown in FIGS. 9B and 9C, the wideband jitter and the narrowband jitter calculated based on the N cycle to N cycle jitter string both follow the Gaussian distribution. In other words, the effect of the sinusoidal jitter is decreased by measuring the N cycle to N cycle jitter string.

Here, when transforming Expression 4 into Expression 5, in a case where the interval at which data is extracted contains an error in relation to the jitter period T_{PM}, the effect of the sinusoidal jitter on the measurement result can be examined.

Expression 5 results in Expression 8 when the aforementioned data interval is to:

$${T}_{PM} ( 1 + \frac{ɛ}{2 π} )$$

### Expression 8:

$$Δφ ( t ; {T}_{PM} ) = \{ ( t , {J}_{0} cos ( k ɛ ) sin ( β ) + n ( t ) ) \vert t = {kT}_{PM} ( 1 + \frac{ɛ}{2 π} ) \}$$

When Expression 8 is used to calculate the N-period jitter, Expression 9 is obtained.

### Expression 9:

$$\begin{matrix}J [ k ; {T}_{PM} ] = \{ ( k , n [ k + 1 ] - n [ k ] + {\tilde{J}}_{0} [ cos ( ( k + 1 ) ɛ ) - cos ( k ɛ ) ] ) \vert k \\ = {kT}_{PM} ( 1 + \frac{ɛ}{2 π} ) \}\end{matrix}$$

It should be noted that:

\tilde{J}₀=J₀ sin β

As shown by Expression 9, the effect of the sinusoidal jitter, including the term J₀ sin β, remains when the data interval includes an error in relation to the integer multiple of the jitter period. It should be noted that if the error ε is very small, the remaining phase modulation term, including the term J₀ sin β, corresponds to a full scale vicinity of a cosine wave, namely an area in a proximity of the peaks and troughs of the waveform. Since the change of the cosine wave in the full scale vicinity is gradual, Expression 10 can be created.

### Expression 10:

$$cos ( l ɛ ) \approx 1 - \frac{{( l ɛ )}^{2}}{2}$$

Applying Expression 10 to Expression 9 results in Expression 11. Expression 11:

$$J [ k ; {T}_{PM} ] = \{ ( k , n [ k + 1 ] - n [ k ] + O ( {ɛ}^{2} ) ) \vert k = {kT}_{PM} ( 1 + \frac{ɛ}{2 π} ) \}$$

In other words, the error caused by the remaining phase modulation is approximately equal to the value of squared.

When calculating the N cycle to N cycle jitter, as seen from Expression 10, the errors approximately equal to ε squared cancel out, resulting in Expression 12.

### Expression 12:

$${J}_{CC} [ k ; {T}_{PM} ] = \{ ( k , n [ k + 2 ] - n [ k ] + O ( {ɛ}^{4} ) ) \vert k = {kT}_{PM} ( 1 + \frac{ɛ}{2 π} ) \}$$

More specifically, the error caused by the remaining phase modulation is approximately the value of ε to the fourth power, which is extremely small. Therefore, the effect of the sinusoidal jitter can be reduced by measuring the N cycle to N cycle jitter as shown in FIG. 9C.

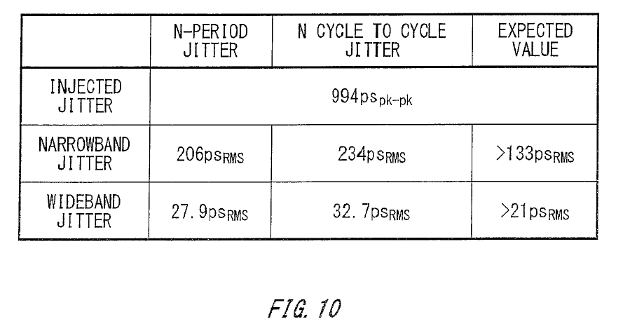

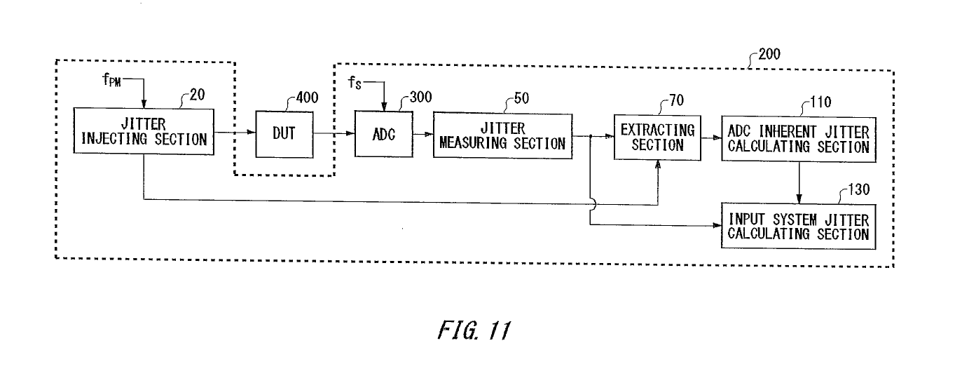

FIG. 10 shows exemplary values of the result of the experiments shown in FIGS. 8A to 9C. In the present embodiment, the injected sinusoidal jitter is several multiples of ten greater than the wideband jitter to be measured, as shown in FIG. 10. The RMS value of the wideband jitter is greater than the inherent phase noise of the sampling clock (in the present embodiment, 20.8 ps_{RMS}), which is an acceptable result. The RMS value of the narrowband jitter is greater than the inherent phase noise of the sampling clock and the RMS value of the timing jitter calculated from the correlation value of the measurement signal, which is also an acceptable result.

The RMS value of the timing jitter can be calculated by the expression below, for example.

$$ρ = 1 - \frac{{σ}_{J}^{2}}{2 {σ}_{Δφ}^{2}}$$

Here, ρ represents the correlation function among the pieces of data extracted by the extracting section 70, σJ represents the period jitter of the sampling clock, and σΔφ represents the timing jitter. The experimental results shown in FIGS. 8A to 10 confirm that the measurement apparatus 100 can measure the wideband jitter and the narrowband jitter.

From the above, it is understood that the internal timing noise n(t) of the sampling system under test can be directly measured by obtaining the N-period jitter or the N cycle to N cycle jitter in the sampling system based on sampling of the waveform that is phase modulated by the sine wave or the like. When the sampling system under test is an AD converter, the n(t) indicates the sampling jitter.

FIG. 11 shows an exemplary configuration of a measurement apparatus 200 according to another embodiment. The measurement apparatus 200 is an apparatus that measures the jitter occurring in a device under test 400, and is provided with the jitter injecting section 20, the AD converter 300, the jitter measuring section 50, the extracting section 70, an ADC inherent jitter calculating section 110, and an input system jitter calculating section 130. The device under test 400 is a device including a semiconductor circuit or the like, for example.

The jitter injecting section 20 causes the device under test 400 to output a signal under measurement, into which is injected jitter of the deterministic signal having a predetermined jitter period f_{PM}. For example, the device under test 400 may include a modulator that modulates the signal under measurement, which is generated within its internal circuit, and outputs the thus modulated signal, and the jitter injecting section 20 may inject the sinusoidal jitter or the like into the signal under measurement by controlling the modulator included in the device under test 400.

In a case where the device under test 400 is a PLL circuit, the jitter injecting section 20 may inject the sinusoidal jitter to the signal under measurement by superimposing the sinusoidal jitter onto the control signal supplied to a voltage controlled oscillator of the PLL circuit. The jitter injecting section 20 may also inject the sinusoidal jitter or the like to the signal to be measured by using other known methods.

The AD converter 300 detects the level of the signal under measurement that is output by the device under test 400, according to the frequency fs of the sampling clock supplied thereto. The AD converter 300 may be the same as the AD converter 300 described in relation to FIGS. 1 to 10.

The jitter measuring section 50 measures the jitter string of the digital signal output by the AD converter 300. The jitter measuring section 50 may be the same as the jitter measuring section 50 described in relation to FIGS. 1 to 10.

The extracting section 70 extracts the data from the jitter string output by the jitter measuring section 50 at intervals according to the period f_{PM} of the jitter injected by the jitter injecting section 20. The extracting section 70 may be the same as the extracting section 70 described in relation to FIGS. 1 to 10.

The ADC inherent jitter calculating section 110, also known as the converter under test inherent jitter calculating section, calculates the jitter occurring in the AD converter 300 based on the data extracted by the extracting section 70. The ADC inherent jitter calculating section 110 may be the same as the jitter calculating section 90 described in relation to FIGS. 1 to 10. For example, the ADC inherent jitter calculating section 110 may calculate the N-period jitter described above.

The input system jitter calculating section 130 calculates the jitter included in the signal under measurement based on a value obtained by subtracting the jitter value calculated by the ADC inherent jitter calculating section 110 from the jitter value of the jitter string measured by the jitter measuring section 50. For example, the input system jitter calculating section 130 may calculate the RMS value of the jitter included in the signal under measurement as being equal to a value obtained by subtracting the RMS value calculated by the ADC inherent jitter calculating section 110 from the RMS value of the jitter string measured by the jitter measuring section 50.

By using such a configuration, the effect of the jitter occurring in the AD converter 300 can be eliminated from the measurement result, so that the jitter occurring in the device under test 400 can be accurately measured. Furthermore, the jitter occurring in the AD converter 300 and the jitter occurring in the device under test 400 can be separated and measured simultaneously.

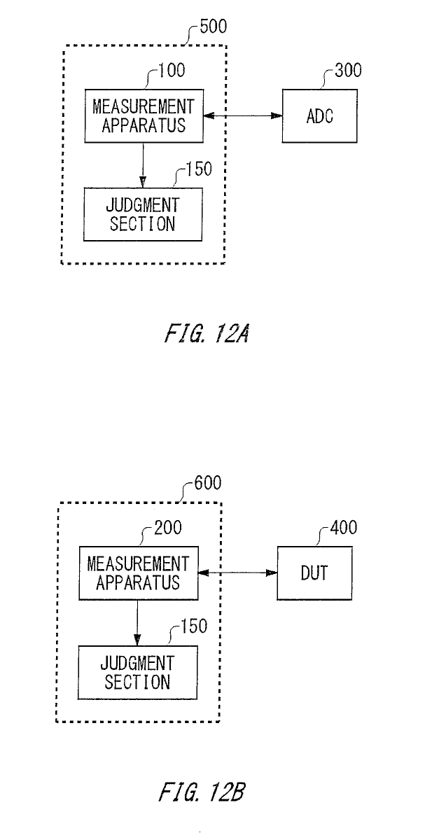

FIG. 12A shows an exemplary configuration of a test apparatus 500 according to another embodiment. The test apparatus 500 is an apparatus that tests the AD converter 300, and is provided with the measurement apparatus 100 and a judgment section 150. The AD converter 300 may be the same as the AD converter 300 described in relation to FIGS. 1 to 10. Furthermore, the measurement apparatus 100 may be the same as the measurement apparatus 100 described in relation to FIGS. 1 to 10.

The judgment section 150 makes a judgment concerning pass/fail of the AD converter 300 based on the jitter measured by the measurement apparatus 100. For example, the measurement apparatus 100 may measure the RMS values in the narrowband or the wideband of the N-period jitter, the N cycle to N cycle jitter, and the timing jitter, as described in relation to FIG. 10. The judgment section 150 may make a judgment concerning pass/fail of the AD converter 300 based on whether the RMS values measured by the measurement apparatus 100 are within a predetermined range.

As described above, the measurement apparatus 100 can accurately measure the internal timing noise of the AD converter 300. Therefore, the test apparatus 500 of the present embodiment can accurately measure pass/fail of the AD converter 300.

FIG. 12B shows an exemplary configuration of a test apparatus 600 according to another embodiment. The test apparatus 600 is an apparatus that tests the device under test 400, and is provided with the measurement apparatus 200 and the judgment section 150. The device under test 400 may be the same as the device under test 400 shown in FIG. 11.

The measurement apparatus 200 measures the jitter occurring in the device under test 400. The measurement apparatus 200 may be the same as the measurement apparatus 200 shown in FIG. 11. The judgment section 150 makes a judgment concerning pass/fail of the AD converter 300 based on jitter measured by the measurement apparatus 200. The judgment section 150 may make a judgment concerning pass/fail of the AD converter 300 based on whether the RMS values measured by the measurement apparatus 200 are within a predetermined range, in the same manner as the judgment section 150 shown in FIG. 12A.

As described above, the measurement apparatus 200 can accurately measure the jitter occurring in the device under test 400. Therefore, the test apparatus 600 of the present embodiment can accurately measure pass/fail of the device under test 400.

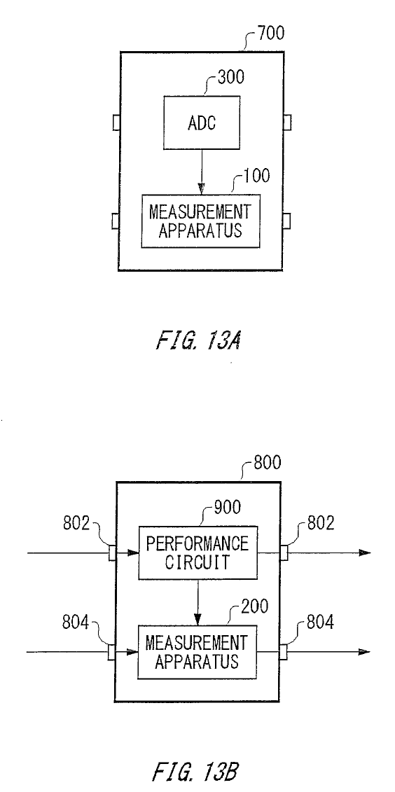

FIG. 13A shows an exemplary configuration of an electronic device 700 according to another embodiment. The electronic device 700 is, for example, a semiconductor chip that has the AD converter 300 and the measurement apparatus 100 built-in. The measurement apparatus 100 and the AD converter 300 may be the same as the measurement apparatus 100 and the AD converter 300 described in relation to FIGS. 1 to 10.

The AD converter 300 may be a circuit that converts an analog signal supplied thereto from the outside into a digital signal, and outputs the resulting digital signal, for example. The measurement apparatus 100 may function as a portion of a so-called BIST (built in self test) circuit.

FIG. 13B shows an exemplary configuration of an electronic device 800 according to another embodiment. The electronic device 800 may be, for example, a semiconductor chip that has a performance circuit 900 and the measurement apparatus 200 built-in. The performance circuit 900 may be a circuit that operates during actual operation of the electronic device 800. For example, the performance circuit 900 generates an output signal in response to an input signal supplied thereto by an input/output pin 802 of the electronic device 800, and outputs the generated signal to the outside via the input/output pin 802.

The measurement apparatus 200 may be the same as the measurement apparatus 200 described in relation to FIG. 11. The measurement apparatus 200 of the present embodiment measures the jitter occurring in the performance circuit 900. For example, the measurement apparatus 200 may measure the jitter occurring in the performance circuit 900, based on the output signal generated by the performance circuit 900.

The measurement apparatus 200 may function as a portion of the so-called BIST circuit. The measurement apparatus 200 may measure the jitter occurring in the performance circuit 900 according to a control signal supplied thereto from a BIST pin 804 that is not used during the actual operation of the electronic device 800. The measurement apparatus 200 may output the measured jitter to the outside via the BIST pin 804.

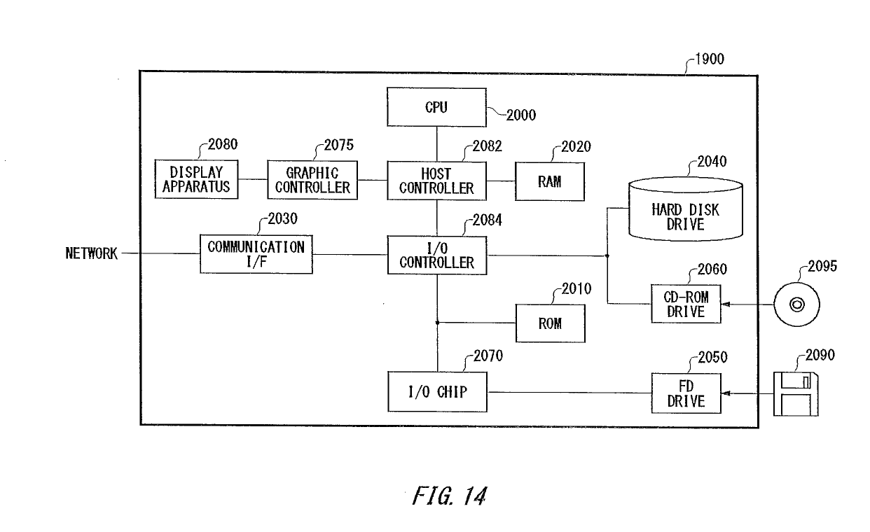

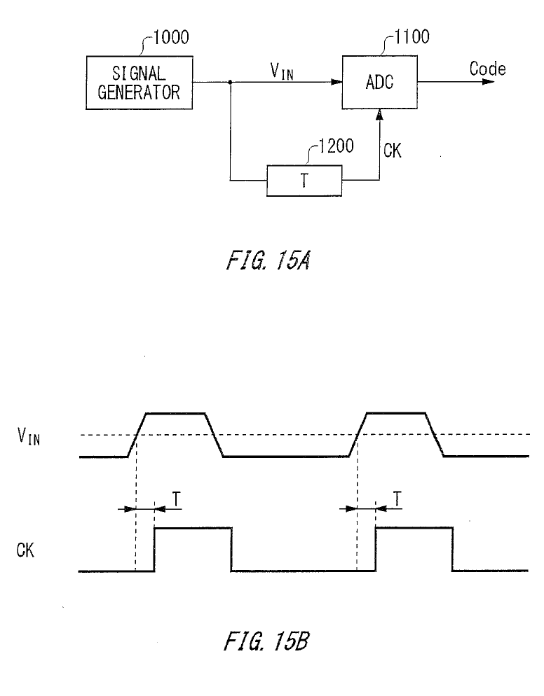

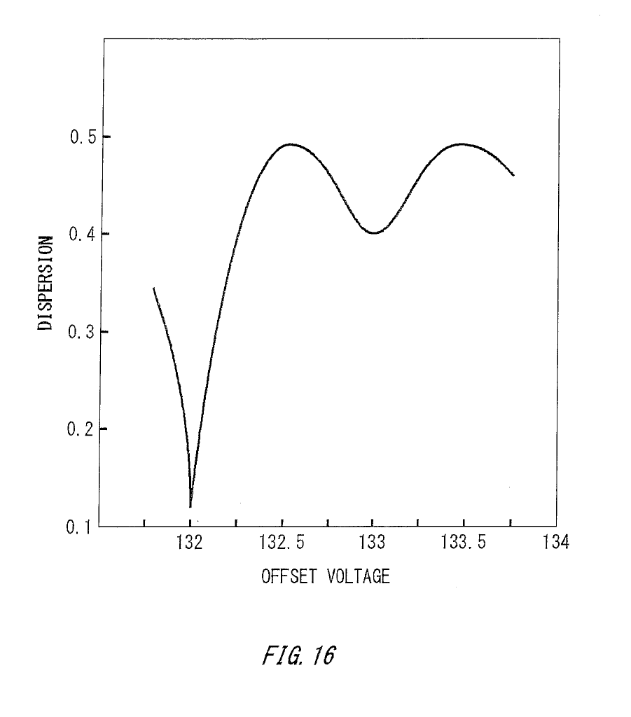

FIG. 14 shows an exemplary configuration of a computer 1900. The computer 1900 may control the measurement apparatus 100, the measurement apparatus 200, the test apparatus 500, or the test apparatus 600 described in relation to FIGS. 1 to 13B to function as described in FIGS. 1 to 13B, based on a program supplied thereto. For example, the computer 1900 may cause the measurement apparatus 100 to function as the measurement signal generating section 10, the jitter injecting section 20, the jitter measuring section 50, the extracting section 70, and the jitter calculating section 90 described in relation to FIG. 1.

Furthermore, the computer 1900 may function as a portion of the measurement apparatus 100, the measurement apparatus 200, the test apparatus 500, or the test apparatus 600. For example, the computer 1900 may function as the jitter measuring section 50, the extracting section 70, and the jitter calculating section 90 in the measurement apparatus 100. As another example, the computer 1900 may function as the jitter measuring section 50, the extracting section 70, the ADC inherent jitter calculating section 110, and the input system jitter calculating section 130 in the measurement apparatus 200.

The program provided to the computer 1900 may allow the computer 1900 to control the measurement apparatus 100, the measurement apparatus 200, the test apparatus 500, or the test apparatus 600. Furthermore, the program may cause the computer 1900 to function as a portion of the measurement apparatus 100, the measurement apparatus 200, the test apparatus 500, or the test apparatus 600.

The computer 1900 according to the present embodiment is provided with a CPU peripheral section, an input/output section, and a legacy input/output section. The CPU peripheral section includes a CPU 2000, a RAM 2020, a graphic controller 2075, and a displaying apparatus 2080, all of which are connected to each other by a host controller 2082. The input/output section includes a communication interface 2030, a hard disk drive 2040, and a CD-ROM drive 2060, all of which are connected to the host controller 2082 by an input/output controller 2084. The legacy input/output section includes a ROM 2010, a flexible disk drive 2050, and an input/output chip 2070, all of which are connected to the input/output controller 2084.

The host controller 2082 is connected to the RAM 2020 and is also connected to the CPU 2000 and graphic controller 2075 accessing the RAM 2020 at a high transfer rate. The CPU 2000 operates to control each section based on programs stored in the ROM 2010 and the RAM 2020. The graphic controller 2075 acquires image data generated by the CPU 2000 or the like on a frame buffer disposed inside the RAM 2020 and displays the image data in the displaying apparatus 2080. In addition, the graphic controller 2075 may internally include the frame buffer storing the image data generated by the CPU 2000 or the like.

The input/output controller 2084 connects the communication interface 2030 serving as a relatively high-speed input/output apparatus, the hard disk drive 2040, and the CD-ROM drive 2060 to the host controller 2082. The communication interface 2030 communicates with other apparatuses via a network. The hard disk drive 2040 stores the programs and data used by the CPU 2000 housed in the computer 1900. The CD-ROM drive 2060 reads the programs and data from a CD-ROM 2095 and provides the read information to the hard disk drive 2040 via the RAM 2020.

Furthermore, the input/output controller 2084 is connected to the ROM 2010, and is also connected to the flexible disk drive 2050 and the input/output chip 2070 serving as a relatively high-speed input/output apparatus. The ROM 2010 stores a boot program performed when the computer 1900 starts up, a program relying on the hardware of the computer 1900, and the like. The flexible disk drive 2050 reads programs or data from a flexible disk 2090 and supplies the read information to the hard disk drive 2040 via the RAM 2020. The input/output chip 2070 connects the flexible disk drive 2050 to each of the input/output apparatuses via, for example, a parallel port, a serial port, a keyboard port, a mouse port, or the like.

The programs provided to the hard disk drive 2040 via the RAM 2020 are stored in a recording medium, such as the flexible disk 2090, the CD-ROM 2095, or an IC card, and provided by a user. The programs are read from recording medium, installed in the hard disk drive 2040 inside the computer 1900 via the RAM 2020, and performed by the CPU 2000.

The programs installed in the computer 1900 may be executed by the CPU 200 or the like to cause the computer 1900 to function as the measurement apparatus 100, the measurement apparatus 200, the test apparatus 500, or the test apparatus 600, or may cause the computer 1900 to function as a portion of the measurement apparatus 100, the measurement apparatus 200, the test apparatus 500, or the test apparatus 600.

The programs shown above may also be stored in an external recording medium. The flexible disk 2090, the CD-ROM 2095, an optical recording medium such as a DVD or CD, a magneto-optical recording medium, a tape medium, a semiconductor memory such as an IC card, or the like can be used as the recording medium. Furthermore, a storage apparatus such as a hard disk or RAM that is provided with a server system connected to the Internet or a specialized communication network may be used to provide the programs to the computer 1900 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

As made clear from the above, by using the embodiments of the present invention, the effects of the inherent phase noise in the sampling clock, the noise in the measurement signal, and the like can be eliminated, so that the aperture jitter occurring in the AD converter can be measured. Furthermore, when the output signal of the DUT is measured using the AD converter, the jitter of the measurement system occurring in the AD converter and the jitter of the input system occurring in the DUT can be measured separately.

What is claimed is:

1. A measurement apparatus that measures jitter occurring in a data converter, comprising:
a measurement signal generating section that generates a measurement signal having a substantially constant period;
a jitter injecting section that injects jitter of a deterministic signal having a predetermined jitter period into the measurement signal, and that inputs the resulting signal to the data converter;
a jitter measuring section that measures a jitter string of a digital signal output by the data converter; and
an extracting section that extracts data of the jitter string according to the jitter period of the jitter injected by the jitter injecting section.

2. The measurement apparatus according to claim 1, further comprising a jitter calculating section that calculates N-period jitter occurring in the data converter, based on the data extracted by the extracting section.

3. The measurement apparatus according to claim 1, further comprising a jitter calculating section that calculates N cycle to N cycle jitter occurring in the data converter, based on the data extracted by the extracting section.

4. The measurement apparatus according to any one of claim 2 and claim 3, wherein the jitter calculating section calculates timing jitter occurring in the data converter, based on the N-period jitter or the N cycle jitter.

5. The measurement apparatus according to claim 1, wherein the jitter injecting section injects sinusoidal jitter into the measurement signal.

6. The measurement apparatus according to claim 1, wherein the jitter injecting section generates jitter whose jitter period is equal to an integer multiple of a sampling period of the data converter.

7. The measurement apparatus according to claim 1, wherein the jitter injecting section injects jitter whose jitter value is larger than a jitter value of jitter included in the measurement signal generated by the measurement signal generating section, into the measurement signal.

8. The measurement apparatus according to claim 6, wherein the jitter injecting section adjusts a jitter value of the jitter to be injected into the measurement signal such that a correlation value between pieces of data extracted by the extracting section is substantially equal to one.

9. The measurement apparatus according to claim 1, wherein the jitter measuring section includes:
an analytic signal calculating section that calculates an analytic signal of the digital signal;
an instantaneous phase calculating section that calculates an instantaneous phase of the digital signal based on the analytic signal; and
an instantaneous phase noise calculating section that calculates instantaneous phase noise of the digital signal based on the instantaneous phase.

10. A measurement apparatus that measures jitter occurring in a device under test, comprising:
a jitter injecting section that injects jitter of a deterministic signal having a predetermined jitter period into a signal under measurement, and causes the device under test to output the signal under measurement;
a data converter that detects a level of the signal under measurement according to a timing signal supplied thereto;
a jitter measuring section that measures a jitter string of a digital signal output by the data converter;
an extracting section that extracts data of the jitter string according to the jitter period of the jitter injected by the jitter injecting section;
a converter under test inherent jitter calculating section that calculates jitter occurring in the data converter, based on the data extracted by the extracting section; and
an input system jitter calculating section that calculates jitter included in the signal under measurement based on a value obtained by subtracting a jitter value calculated by the converter under test inherent jitter calculating section from a jitter value of the jitter string measured by the jitter measuring section.

11. A measurement method for measuring jitter occurring in a data converter, comprising:
generating a measurement signal having a substantially constant period;
injecting jitter of a deterministic signal having a predetermined jitter period into the measurement signal, and inputting the resulting signal to the data converter;
measuring a jitter string of a digital signal output by the data converter; and
extracting data of the jitter string according to the jitter period of the jitter injected into the measurement signal.

12. A measurement method for measuring jitter occurring in a device under test, comprising:
injecting jitter of a deterministic signal having a predetermined jitter period into a signal under measurement, and causing the device under test to output the signal under measurement;
detecting a level of the signal under measurement according to a timing signal supplied thereto, by using a data converter;
measuring a jitter string of a digital signal output by the data converter;
extracting data of the jitter string according to the jitter period of the jitter injected into the signal under measurement;
calculating period jitter occurring in the data converter, based on the extracted data; and
calculating jitter included in the signal under measurement based on a value obtained by subtracting a jitter value of the period jitter from a jitter value of the jitter string.

13. A test apparatus that tests a data converter, comprising:
the measurement apparatus according to claim 1, that measures jitter occurring in the data converter; and
a judgment section that makes a judgment concerning pass/fail of the data converter based on the jitter measured by the measurement apparatus.

14. A test apparatus that tests a device under test, comprising:
the measurement apparatus according to claim 10, that measures jitter occurring in the device under test; and
a judgment section that makes a judgment concerning pass/fail of the data converter based on the jitter measured by the measurement apparatus.

15. An electronic device, comprising:
a data converter; and
the measurement apparatus according to claim 1, that measures jitter occurring in the data converter.

16. An electronic device, comprising:
a performance circuit; and
the measurement apparatus according to claim 10, that measures jitter occurring in the performance circuit.

17. A recording medium that stores thereon a program that causes a measurement apparatus to function in a manner to measure jitter occurring in a data converter, the program causing the measurement apparatus to function as:
a measurement signal generating section that generates a measurement signal having a substantially constant period;
a jitter injecting section that injects jitter of a deterministic signal having a predetermined jitter period into the measurement signal, and that inputs the resulting signal to the data converter;
a jitter measuring section that measures a jitter string of a digital signal output by the data converter; and
an extracting section that extracts data of the jitter string according to the jitter period of the jitter injected by the jitter injecting section.

18. A recording medium that stores thereon a program that causes a measurement apparatus to function in a manner to measure jitter occurring in a device under test, the program causing the measurement apparatus to function as:
a jitter injecting section that injects jitter of a deterministic signal having a predetermined jitter period into a signal under measurement, and causes the device under test to output the signal under measurement;
a data converter that detects a level of the signal under measurement according to a timing signal supplied thereto;
a jitter measuring section that measures a jitter string of a digital signal output by the data converter;
an extracting section that extracts data of the jitter string according to the jitter period of the jitter injected by the jitter injecting section;
a converter under test inherent jitter calculating section that calculates N-period jitter occurring in the data converter, based on the data extracted by the extracting section; and
an input system jitter calculating section that calculates jitter included in the signal under measurement based on a value obtained by subtracting a jitter value of the period jitter calculated by the converter under test inherent jitter calculating section from a jitter value of the jitter string measured by the jitter measuring section.
